(19) United States
(12) Patent Application Publication
(10) Pub. No.: US 2024/0407465 A1
(43) Pub. Date: Dec. 12, 2024

(54) AEROSOL-GENERATING DEVICE

(71) Applicant: KT&G CORPORATION, Daejeon (KR)

(72) Inventors: Jueon PARK, Seoul (KR); Taehun KIM, Yongin-si Gyeonggi-do (KR); Hyungjin JUNG, Seoul (KR); Jungho HAN, Daejeon (KR)

(73) Assignee: KT&G CORPORATION, Daejeon (KR)

(21) Appl. No.: 18/697,560

(22) PCT Filed: Oct. 14, 2022
(86) PCT No.: PCT/KR2022/015643

§ 371 Date: Apr. 1, 2024

(30) Foreign Application Priority Data
Oct. 20, 2021 (KR) 10-2021-0140608
Feb. 17, 2022 (KR) 10-2022-0020992

(51) Int. Cl. A24F 40/60; A24F 40/10; A24F 40/20; A24F 40/465; F21V 33/00; F21Y 115/10; H01H 13/02

(52) U.S. Cl. CPC A24F 40/60; A24F 40/10; A24F 40/20; A24F 40/465; F21V 33/0004; H01H 13/023; F21Y 2115/10

(57) ABSTRACT

An aerosol-generating device is disclosed. The aerosol-generating device of the disclosure includes a body shaped to define an elongated insertion space that is open to an outside; a button positioned relative to a side of the body; a substrate disposed in the body and facing the button; an actuator disposed between the substrate and the button to provide elastic force relative to the button; and a light source coupled to the substrate, adjacent to the button, wherein the light source is configured to emit light in a direction parallel to the button and the substrate.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to uniformly diffuse light that is emitted to the outside of a button.

It is still another object of the present disclosure to reduce the required number of light sources and power consumption.

### Technical Solution

In accordance with an aspect of the present disclosure for accomplishing the above and other objects, there is provided an aerosol-generating device including a body shaped to define an elongated insertion space that is open to an outside; a button positioned relative to a side of the body; a substrate disposed in the body and facing the button; an actuator disposed between the substrate and the button to provide elastic force relative to the button; and a light source coupled to the substrate, adjacent to the button, wherein the light source is configured to emit light in a direction parallel to the button and the substrate.

### Advantageous Effects

According to at least one of embodiments of the present disclosure, it may be possible to uniformly diffuse light that is emitted to the outside of a button.

According to at least one of embodiments of the present disclosure, it may be possible to reduce the required number of light sources and power consumption.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

FIGS. 1 to 12 are views showing examples of an aerosol-generating device according to embodiments of the present disclosure.

### BEST MODE

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

With respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

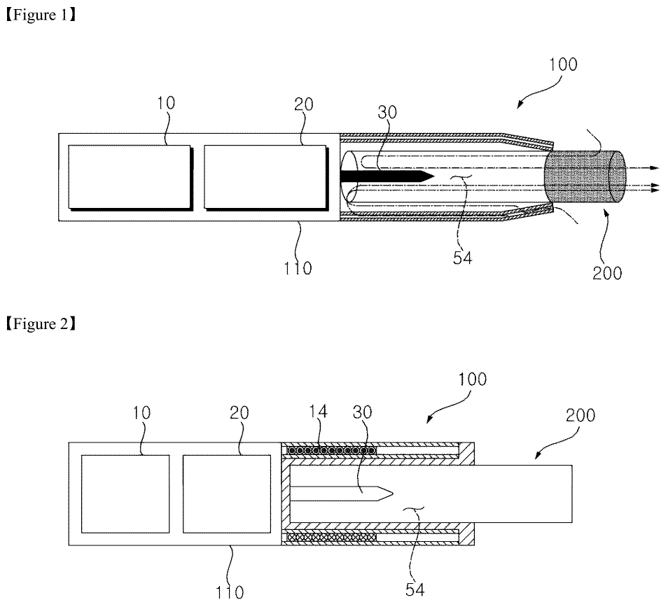

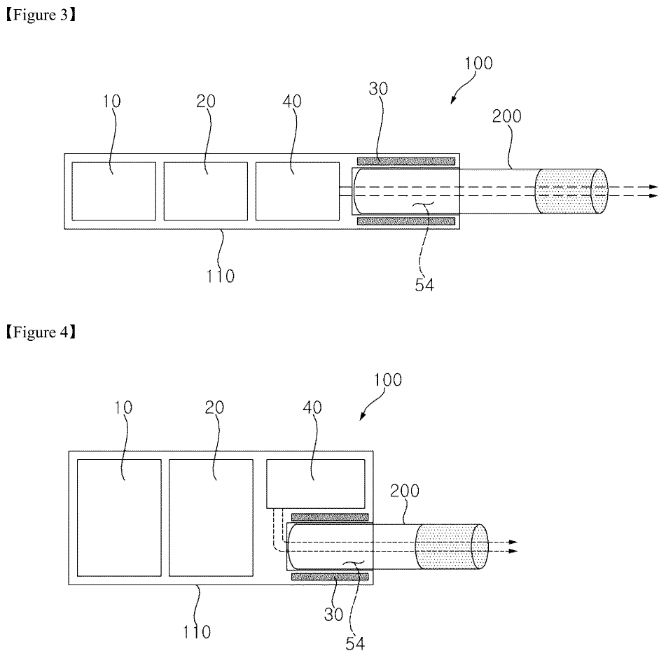

Referring to FIGS. 1 and 2, an aerosol-generating device 100 may include at least one of a battery 10, a controller 20, or a heater 30. Referring to FIGS. 3 and 4, the aerosol-generating device 100 may further include a cartridge 40. At least one of the battery 10, the controller 20, or the heater 30 may be disposed in a body 110.

Referring to FIGS. 1 and 2, the battery 10, the controller 20, and the heater 30 may be disposed in a line. Referring to FIG. 3, the battery 10, the controller 20, the heater 30, and the cartridge 40 may be disposed in a line. Referring to FIG. 4, the cartridge 40 and the heater 30 may be disposed parallel to each other so as to face each other. The internal structure of the aerosol-generating device 100 is not limited to that shown in the drawings.

The aerosol-generating device 100 may have an insertion space 54 defined therein. The insertion space 54 may be open in the upward direction of the aerosol-generating device 100.

The insertion space 54 may have a cylindrical shape. A stick 200 may be inserted into the insertion space 54.

The heater 30 may be disposed around the insertion space 54 or in the insertion space 54. The heater 30 may heat the insertion space and/or the stick 200 inserted into the insertion space 54. The heater 30 may heat the stick 200 to generate an aerosol. The heater 30 may be an electrically resistive heater. The heater 30 may be made of a conductive metal.

Referring to FIGS. 1 and 2, the heater 30 may protrude upwards from the bottom of the insertion space 54. The heater 30 may have an elongated rod shape. The heater 30 may have a pointed top. When the stick 200 is inserted into the insertion space 54, the heater 30 may be inserted into the stick 200. Referring to FIG. 1, the heater 30 may directly generate heat upon receiving current from the battery 10. Referring to FIG. 2, an induction coil 14 may surround the heater 30 and the insertion space 54. The induction coil 14 may be wound around the insertion space 54. The heater 30 may generate heat due to a magnetic field generated by alternating current flowing through the induction coil 14. The magnetic field may pass through the heater 30 to generate an eddy current in the heater 30. The current may cause the heater 30 to generate heat.

Referring to FIGS. 3 and 4, the heater 30 may surround the insertion space 54. The heater 30 may surround the lower portion of the stick 200 inserted into the insertion space 54. The heater 30 may extend in the circumferential direction along the circumference of the insertion space 54. The heater 30 may be formed in a ring shape or a cylindrical shape. The heater 30 may directly generate heat upon receiving current from the battery 10. Although the heater 30 is illustrated in FIGS. 3 and 4 as being included in the aerosol-generating device 100, the heater 30 may not be included in the aerosol-generating device as needed.

The battery 10 may supply power to operate at least one of the controller 20, the heater 30, or the cartridge 40. The battery 10 may supply power required for driving a display, a sensor, a motor, etc. mounted in the aerosol-generating device 100.

The controller 20 may control the overall operation of the aerosol-generating device 100. The controller 20 may control the operation of at least one of the battery 10, the heater 30, or the cartridge 40. The controller 20 may control the operation of the display, the sensor, the motor, etc. mounted in the aerosol-generating device 100. The controller 20 may check the state of each of the components of the aerosol-generating device 100 to determine whether the aerosol-generating device 100 is in an operable state.

The cartridge 40 may store liquid therein. The cartridge 40 may generate an aerosol using the liquid stored therein. The aerosol generated in the cartridge 40 may be delivered to a user via the stick 200 inserted into the aerosol-generating device 100.

The lower end of the stick 200 may be inserted into the insertion space 54, and the upper end thereof may be exposed to the outside from the insertion space 54. The user may inhale air in the state of holding the exposed upper end of the stick 200 in the mouth. The air may pass through the aerosol-generating device 100, and may then be delivered to the user together with an aerosol.

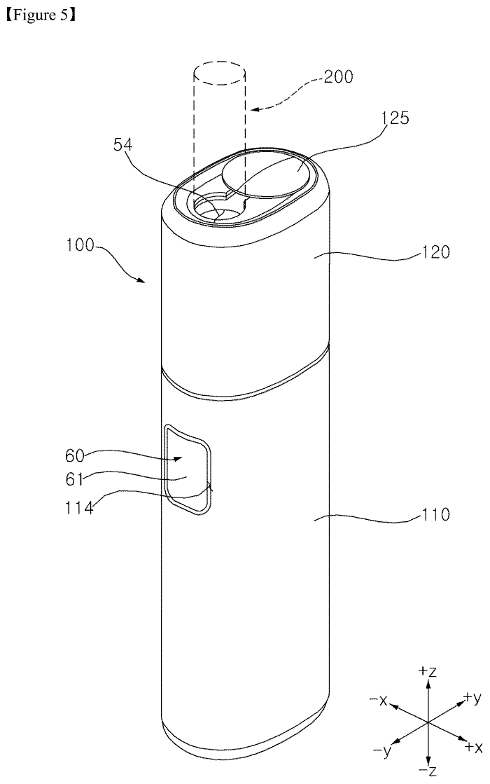

Referring to FIG. 5, a cap 120 may be coupled to the upper portion of the body 110 and may cover the upper portion of the body 110. One side of the cap 120 may be open to communicate with the insertion space 54. The cap 120 may include a cover 125 for opening and closing the insertion space 54.

A button assembly 60 may be mounted on one side of the body 110. A button 61 may be disposed on one side of the body 110. A button hole 114 may be formed in such a manner that one side of the body 110 is open. The button 61 may be inserted into the button hole 114. When the button 61 is pressed, the button 61 may move toward the inside of the body 110, and may then return to the original position thereof. The button 61 may be connected to the controller 20. A user may press the button 61 to transmit a command to the controller 20. For example, when the button 61 is pressed, the aerosol-generating device 100 may operate or the operation thereof may be stopped.

In another example, the button hole 114 may not be formed, and the button 61 may be formed on one side of the body. In this case, the button 61 may be integrally formed with one side of the body 110. The button 61 may be made of an elastic material. For example, the button 61 may be made of light transmissive silicone.

Each of the button hole 114 and the button 61 may be elongated in one direction so as to have a long axis and a short axis. For example, the button hole 114 and the button 61 may be formed to be longer in the longitudinal direction than in the lateral direction. In this case, the longitudinal direction may be the long axis, and the lateral direction may be the short axis.

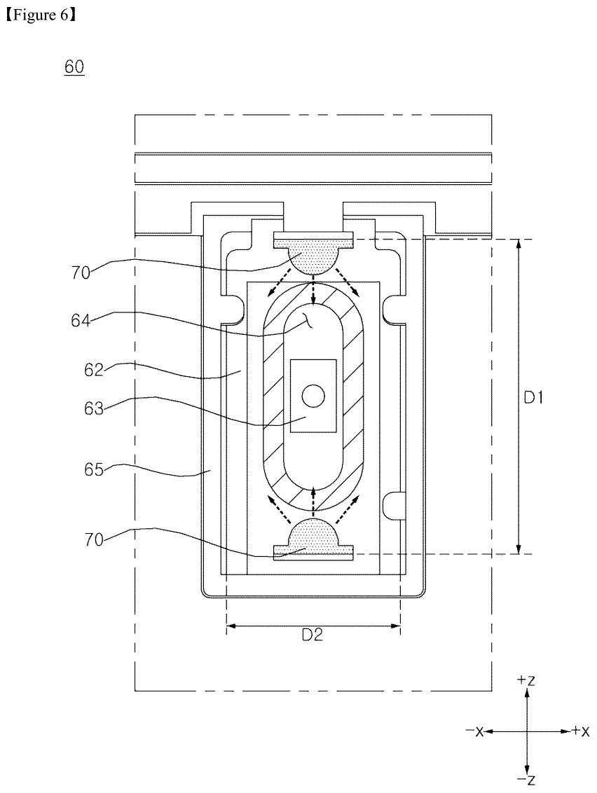

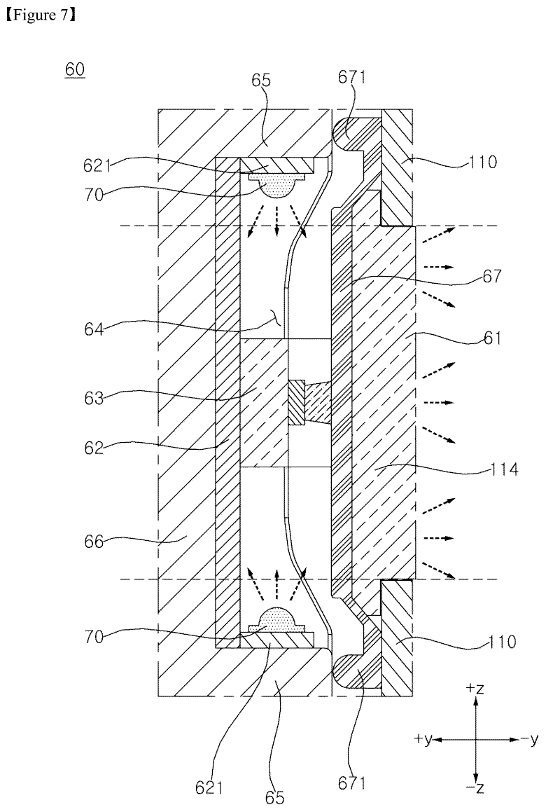

FIG. 6 is a view showing the inside of the button assembly 60, with the button 61 removed therefrom. Referring to FIGS. 6 and 7, the button hole 114 may be formed in such a manner that one side of the body 110 is open. The button 61 may be inserted into the button hole 114. The front portion of the button 61 may have a shape corresponding to the button hole 114 so as to be inserted into the button hole 114, and the rear portion of the button 61 may be disposed behind the button hole 114 so as to catch on a portion of the body 110 around the button hole 114. In another example, the button hole 114 may not be formed, and the button 61 may be integrally formed with one side of the body 110, and may be made of an elastic material.

A substrate 62 may be mounted in the body 110. The substrate 62 may face the button 61 and the button hole 114. The substrate 62 may be disposed behind the button 61. The substrate 62 may be disposed parallel to the button 61 and the button hole 114. For example, the button hole 114, the button 61, and the substrate 62 may be formed in the longitudinal direction. The controller 20 may be mounted on the substrate 62, or may be electrically connected to the substrate 62.

An actuator 63 may be disposed between the substrate 62 and the button 61. One end of the actuator 63 may be coupled to the substrate 62, and the other end thereof may be coupled to the button 61. The substrate 62 may be electrically connected to the actuator 63 to receive a signal from the actuator 63. The actuator 63 may provide elastic force to the button 61 from the substrate 62. When the button 61 moves backwards, that is, toward the inside of the body 110, the button 61 presses the actuator 63 backwards, and the substrate 62 may detect a press signal. The actuator 63 may restore the button 61 forwards. The actuator 63 may be disposed at a position corresponding to the center of the button 61.

A diffusion space 64 may be defined between the substrate 62 and the button 61 or between the substrate 62 and a seal 67. The substrate 62 may cover the rear side of the diffusion space 64. The button 61 or the seal 67 may cover the front side of the diffusion space 64. The actuator 63 may be disposed in the diffusion space 64. The diffusion space 64 may be surrounded by a peripheral wall 65.

The diffusion space 64 and the button hole 114 may have shapes substantially corresponding to each other. The diffusion space 64 may be elongated in one direction so as to have a long axis and a short axis. For example, the length D1 of the diffusion space 64 in the longitudinal direction may be longer than the length D2 thereof in the lateral direction. In addition, the length of the button hole 114 in the longitudinal direction may be longer than the length thereof in the lateral direction.

A substrate support wall 66 may support the rear side of the substrate 62. The substrate support wall 66 may be disposed parallel to the substrate 62. The peripheral wall 65 may protrude forwards from the substrate support wall 66. The peripheral wall 65 may extend along the edge of the diffusion space 64 so as to surround the diffusion space 64. The peripheral wall 65 may surround the periphery of the actuator 63.

The seal 67 may be disposed behind the button 61 inside the body 110. The seal 67 may cover the button hole 114. The seal 67 may be in close contact with a portion the body 110 around the edge of the button hole 114. The edge 671 of the seal 67 may be in close contact with the peripheral wall 65 and the body 110. The center of the seal 67 may be coupled to the actuator 63. The diffusion space 64 may be defined between the substrate 62 and the seal 67. The seal 67 may be made of an elastic material. For example, the seal 67 may be made of rubber or silicone. The seal 67 may prevent external foreign substances such as liquid from being introduced into the device through the button hole 114.

A light source 70 may be disposed adjacent to the button 61 inside the body 110. The light source 70 may be mounted on the substrate 62. The light source 70 may emit light. For example, the light source 70 may be an LED. The light source 70 may be disposed between the substrate 62 and the button 61. The light source 70 may be mounted on the substrate 62. The light source 70 may be oriented toward a region between the substrate 62 and the button 61. The light source 70 may be oriented in a direction parallel to the button 61 and the substrate 62. The light source 70 may be disposed so as to be oriented in a direction other than the forward-backward direction of the button 61. For example, the light source 70 may be disposed so as to be oriented in the longitudinal direction. The light source 70 may emit light in the longitudinal direction in which the light source 70 is oriented.

The button 61 may be light transmissive. The button 61 may be made of a translucent material. The button 61 may diffuse light. The seal 67 may be light transmissive. The seal 67 may be made of a translucent material. The seal 67 may diffuse light. The seal 67 may have relatively high transmittance, and the button 61 may have relatively high optical diffusivity.

The light emitted from the light source 70 may pass through the button 61 and may diffuse to the outside. The light emitted from the light source 70 may pass through the seal 67. The light may pass through the seal 67 and may diffuse forwards. The light may be emitted to the outside through a gap in the button hole 114 formed between the body 110 and the button 61.

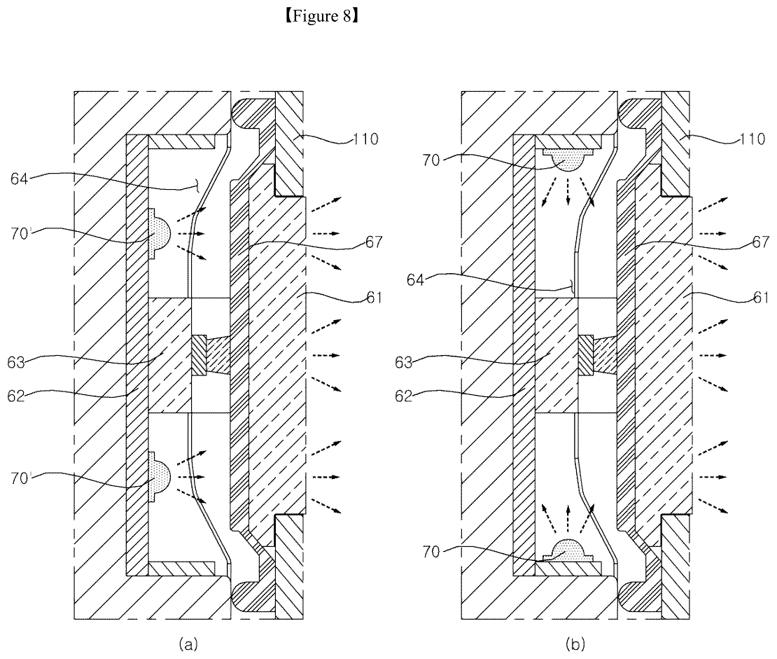

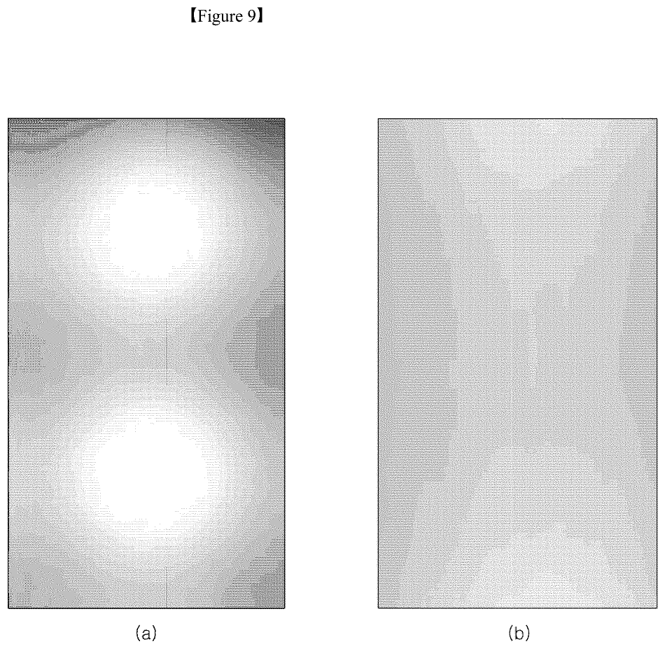

FIG. 8(a) shows a conventional art, and FIG. 8(b) shows an embodiment of the present disclosure. In the conventional art, a light source 70′ is disposed behind the button 61 so as to face the button 61. In the conventional art, because light is intensively radiated to a point in the button 61 corresponding to the light source 70′, a hotspot is generated at the corresponding point, and the light does not uniformly diffuse (refer to FIG. 9(a)).

According to an embodiment of the present disclosure, the light source 70 may be disposed so as to face the diffusion space 64 between the button 61 and the substrate 62. Accordingly, the light source 70 does not directly emit light to the button 61, thereby making it possible to prevent a hotspot from being generated at a specific point and enabling the light to diffuse to the outside relatively uniformly (refer to FIG. 9(b)). In addition, it is possible to reduce the number of light sources 70 required to uniformly diffuse light and power consumption.

Referring back to FIGS. 6 and 7, the light source 70 may be disposed adjacent to the edge of the button hole 114 and/or the edge of the button 61. The light source 70 may be disposed at the edge of the diffusion space 64.

The button hole 114 and/or the button 61 may be elongated in the longitudinal direction. An axis extending in the direction in which the button hole 114 and/or the button 61 is formed to be relatively long may be defined as a long axis, and an axis extending in the direction in which the button hole 114 and/or the button 61 is formed to be relatively short may be defined as a short axis. The diffusion space 64 may be elongated in the longitudinal direction. The length D1 of the diffusion space 64 in the longitudinal direction may be longer than the length D2 thereof in the lateral direction.

The light source 70 may be disposed adjacent to the long-axis end of the button hole 114 or the button 61. The light source 70 may be disposed adjacent to the long-axis end of the diffusion space 64. The light source 70 disposed on one side of the long-axis end may be disposed so as to face the other side of the long-axis end.

The light source 70 may be provided in plural. The light source 70 may be provided in a pair. The pair of light sources 70 may be adjacent to two long-axis ends of the button hole 114 or the button 61. The pair of light sources 70 may face each other.

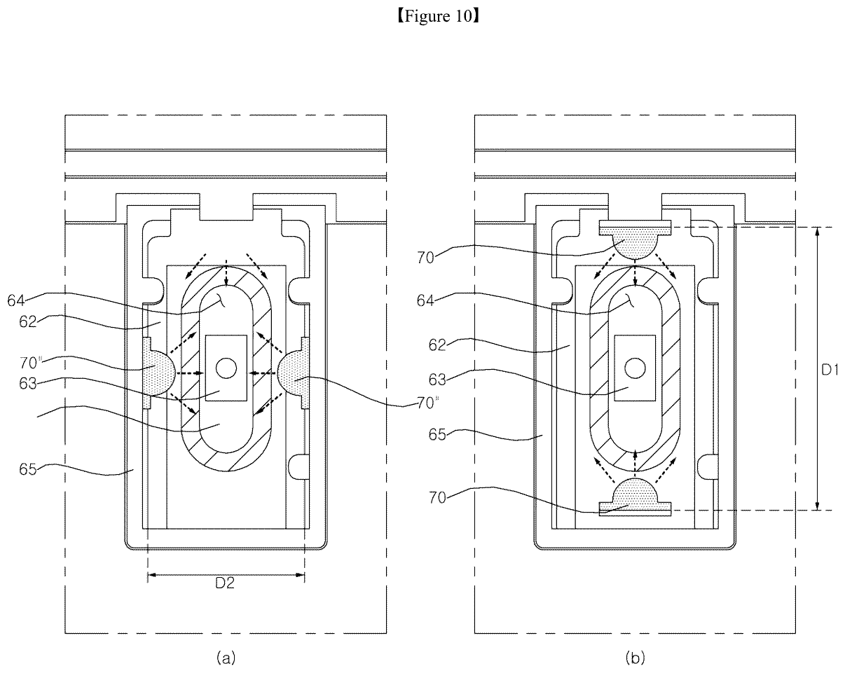

FIG. 10(a) shows the case in which a pair of light sources 70″ is disposed on short-axis ends, and FIG. 10(b) shows an embodiment of the present disclosure in which the pair of light sources 70 is disposed on long-axis ends. Referring to FIG. 10, the distance D2 between the pair of light sources 70″ shown in FIG. 10(a) may be shorter than the distance D1 between the pair of light sources 70 shown in FIG. 10(b).

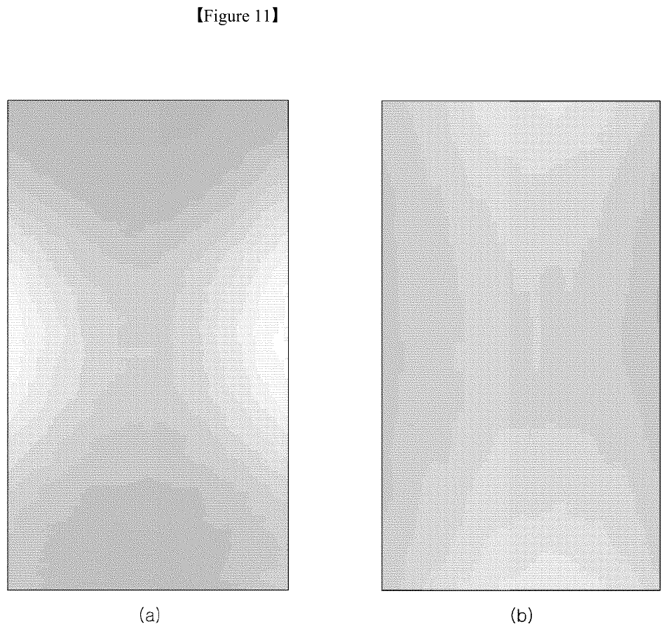

The intensity of light may be inversely proportional to the square of the distance from the light source. As shown in FIG. 10(a), when the pair of light sources 70″ is disposed on two short-axis ends, the intensity of light at the center may be relatively high, and the intensity of light in the periphery may be relatively low compared to the case in which the pair of light sources 70 is disposed on two long-axis ends, as shown in FIG. 10(b) (refer to FIG. 11(a)). That is, as shown in FIG. 10(b), when the pair of light sources 70 is disposed on two long-axis ends, light may uniformly diffuse, rather than being intensively radiated to the center of the button 61 (refer to FIG. 11(b)).

Referring back to FIG. 7, the light source 70 may be disposed at a position corresponding to the outer side of the button hole 114 or the button 61. The light source 70 may be disposed behind a portion of the body 110 that surrounds the button hole 114 or the button 61, and thus may be covered by the body 110. The body 110 may overlap the light source 70 in the forward-backward direction. The body 110 may block the light emitted from the light source 70. Accordingly, direct light from the light source 70 may be prevented from being radiated to the outside of the button hole 114 or the button 61, and the light may uniformly diffuse.

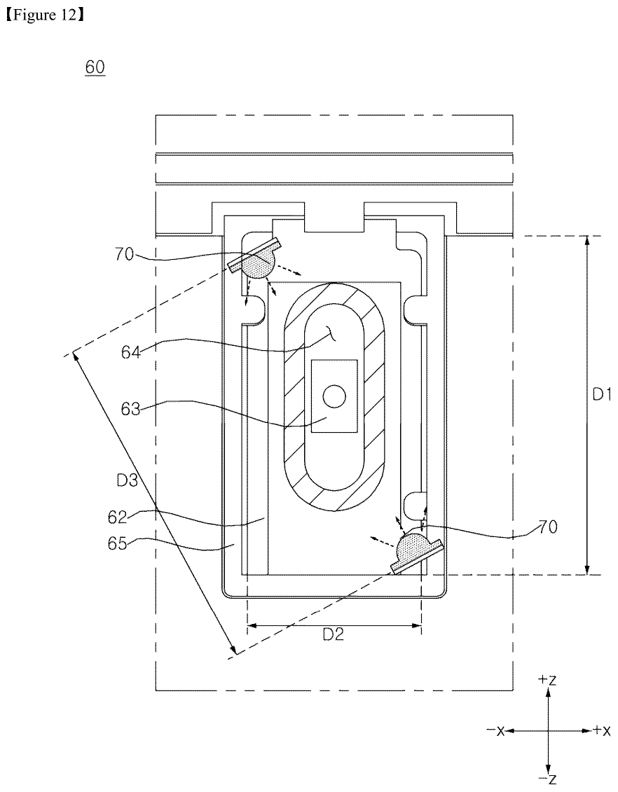

Referring to FIG. 12, each of the diffusion space 64, the button hole 114, and the button 61 may be defined as a rectangular shape in which the length thereof in the longitudinal direction is longer than the length thereof in the lateral direction. The light source 70 may be disposed between the long-axis end of the diffusion space 64 and the short-axis end thereof. The light source 70 may be disposed on the edge of the diffusion space 64. The light source 70 may face the center or the actuator 63. The light source 70 may be provided in a pair, and the pair of light sources 70 may face each other. The pair of light sources 70 may be disposed opposite each other with respect to the actuator 63. The pair of light sources 70 may be disposed at positions separated from each other in an oblique direction with respect to the diffusion space 64. The distance D3 between the pair of light sources 70 may be longer than the long-axis length D1 of the diffusion space 64 or the short-axis length D2 thereof.

Referring to FIGS. 1 to 12, an aerosol-generating device 100 in accordance with one aspect of the present disclosure may include a body shaped to define an elongated insertion space that is open to an outside; a button positioned relative to a side of the body; a substrate disposed in the body and facing the button; an actuator disposed between the substrate and the button to provide elastic force relative to the button; and a light source coupled to the substrate, adjacent to the button, wherein the light source is configured to emit light in a direction parallel to the button and the substrate.

In addition, in accordance with another aspect of the present disclosure, the light source may be disposed adjacent to an edge of the button.

In addition, in accordance with another aspect of the present disclosure, wherein the button may be elongated and includes a long axis and a short axis, and wherein the light source may be disposed adjacent to one end of the button along the long-axis and facing another end of the button along the long-axis.

In addition, in accordance with another aspect of the present disclosure, the aerosol-generating device may further comprise a plurality of light sources, wherein the button is elongated and includes a long axis and a short axis, and wherein a first one of the light sources is disposed adjacent to one end of the button along the long axis and a second one of the light sources is disposed adjacent to another end of the button along the long axis.

In addition, in accordance with another aspect of the present disclosure, wherein the button may comprise a material that is light transmissive.

In addition, in accordance with another aspect of the present disclosure, the aerosol-generating device may further include a light transmissive seal disposed between the substrate and the body to occupy a gap between the button and the body.

In addition, in accordance with another aspect of the present disclosure, wherein the button may be arranged relative to the substrate to define a diffusion space between the button and the substrate, wherein each of the button and the diffusion space may be elongated and includes a long axis and a short axis, and wherein the light source may be disposed between a long axis end of the diffusion space and a short axis end of the diffusion space.

In addition, in accordance with another aspect of the present disclosure, the aerosol-generating device may further include a plurality of light sources, wherein the button may be arranged relative to the substrate to define a diffusion space between the button and the substrate, wherein each of the button and the diffusion space may be elongated and includes a long axis and a short axis, wherein a distance between a first one of the plurality of light sources and a second one of the plurality of light sources may be greater than a length of the long axis of the diffusion space.

In addition, in accordance with another aspect of the present disclosure, the light source may face a position corresponding to the center of the button.

In addition, in accordance with another aspect of the present disclosure, the light source may be disposed at a position corresponding to the outer side of the button.

In addition, in accordance with another aspect of the present disclosure, wherein one side of the body may be shaped to define a button hole, wherein the button hole is sized to receive the button.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a body shaped to define an elongated insertion space that is open to an outside;
a button positioned relative to a side of the body;
a substrate disposed in the body and facing the button;
an actuator disposed between the substrate and the button to provide elastic force relative to the button; and
a light source coupled to the substrate, adjacent to the button, wherein the light source is configured to emit light in a direction parallel to the button and the substrate.

2. The aerosol-generating device according to claim 1, wherein the light source is disposed adjacent to an edge of the button.

3. The aerosol-generating device according to claim 2, wherein the button is elongated and includes a long axis and a short axis, and
wherein the light source is disposed adjacent to one end of the button along the long-axis and facing another end of the button along the long-axis.

4. The aerosol-generating device according to claim 2, further comprising:
a plurality of light sources,
wherein the button is elongated and includes a long axis and a short axis, and
wherein a first one of the light sources is disposed adjacent to one end of the button along the long axis and a second one of the light sources is disposed adjacent to another end of the button along the long axis.

5. The aerosol-generating device according to claim 1, wherein the button comprises a material that is light transmissive.

6. The aerosol-generating device according to claim 1, further comprising:
a light transmissive seal disposed between the substrate and the body to occupy a gap between the button and the body.

7. The aerosol-generating device according to claim 1,
wherein the button is arranged relative to the substrate to define a diffusion space between the button and the substrate,
wherein each of the button and the diffusion space is elongated and includes a long axis and a short axis, and
wherein the light source is disposed between a long axis end of the diffusion space and a short axis end of the diffusion space.

8. The aerosol-generating device according to claim 1, further comprising:
a plurality of light sources,
wherein the button is arranged relative to the substrate to define a diffusion space between the button and the substrate,
wherein each of the button and the diffusion space is elongated and includes a long axis and a short axis,
wherein a distance between a first one of the plurality of light sources and a second one of the plurality of light sources is greater than a length of the long axis of the diffusion space.

9. The aerosol-generating device according to claim 2, wherein the light source faces a position corresponding to a center of the button.

10. The aerosol-generating device according to claim 1, wherein the light source is disposed at a position corresponding to an outer side of the button.

11. The aerosol-generating device according to claim 1, wherein one side of the body is shaped to define a button hole, wherein the button hole is sized to receive the button.
